(19) United States
(12) Patent Application Publication
(10) Pub. No.: US 2017/0337523 A1
(43) Pub. Date: Nov. 23, 2017

(54) EMPLOYEE COORDINATION TO FACILITATE CUSTOMER PICK-UP OF RETAIL ORDERS

(71) Applicant: HEB Grocery Company, LP, San Antonio, TX (US)

(72) Inventors: Gabe William Roach, San Antonio, TX (US); Kedar Dilip Patel, San Antonio, TX (US); Paul Steven Tepfenhart, JR., San Antonio, TX (US); Gregory Sean Hawthorne, San Antonio, TX (US); David Lee Goans, JR., San Antonio, TX (US)

(21) Appl. No.: 15/659,213

(22) Filed: Jul. 25, 2017

Related U.S. Application Data
(63) Continuation-in-part of application No. 15/161,875, filed on May 23, 2016, now abandoned.

(51) Int. Cl. G06Q 10/10; G06Q 10/06; G06Q 10/08

(52) U.S. Cl. CPC G06Q 10/1097; G06Q 10/087; G06Q 10/06311; G06Q 10/06315

(57) ABSTRACT

Systems, computer programs, and methods for coordinating employee activities to facilitate fulfillment of orders for items and/or services sold by retailers and provided to customers for pick-up are provided. In some embodiments, the methods comprise: receiving one or more pick-up orders; generating tasks associated with preparing portions of the one or more pick-up orders using one or more carts; receiving a first electronic confirmation that the portions of the one or more pick-up orders have been prepared; receiving a notification associated with the one or more pick-up orders; generating tasks associated with moving the portions of the pick-up orders prepared for pick-up before the notification from the one or more carts to a pick-up location within a pick-up facility; and receiving a second electronic confirmation that the tasks associated with moving the portions of the one or more pick-up orders have been completed.

### CROSS-REFERENCE TO RELATED APPLICATIONS

This is a continuation-in-part of U.S. application Ser. No. 15/161,875, filed on May 23, 2016, entitled “EMPLOYEE COORDINATION TO FACILITATE CUSTOMER PICK-UP OF RETAIL ORDERS,” the entire disclosure of which is hereby incorporated by reference.

### BACKGROUND

The present disclosure generally relates to systems, computer programs, and methods for coordinating employee activities to facilitate fulfillment of orders for items and/or services sold by retailers and provided to customers for pick-up.

In many situations, retailers of goods and services both own and/or operate one or more “brick-and-mortar” retail stores and/or physical facilities where customers may browse, purchase, and/or pick up items at the site, and also provide an online website or other service for receiving orders from customers remotely. In the methods and systems of the present disclosure, such retailers may allow customers to place orders for goods or services via a website or other service for receiving orders, but rather than shipping or delivering the purchased items to the customer's home (or other location designated by the customer), the retailer may fulfill those orders to the customer by making the set of items purchased by the customer available at a pick-up facility (e.g., a retail store or other “brick-and-mortar” facility) that may be operated or used by the retailer.

Today's consumers demand convenience, speed, selection, and high quality from their retailers regardless of whether such consumers are shopping online or are shopping in a brick-and-mortar establishment. Thus, in order to maximize customer satisfaction, a retailer must meet a consumer's expectations on these attributes when fulfilling items to a customer via customer pick-up. Delayed or unreliable provision of items for customer pick-up at brick-and-mortar facilities may cause customers to be dissatisfied with those systems or the retailer more generally, which ultimately may result in the loss of sales by that retailer. Additionally, where freshness or perishability of the purchased items is important, such as in the context of grocery retailers, ensuring a customer promptly receives items in their freshest form can be difficult.

### SUMMARY

The present disclosure generally relates to systems, computer programs, and methods for coordinating employee activities to facilitate fulfillment of orders for items and/or services sold by retailers and provided to customers for pick-up.

In some embodiments, the present disclosure provides methods that comprise: receiving, using an order pick-up processing server, one or more pick-up orders; in response to the one or more pick-up orders, generating, using the order pick-up processing server, one or more tasks associated with preparing one or more portions of the one or more pick-up orders using one or more carts comprising a plurality of bins, wherein the one or more tasks comprise an assignment of at least one of the plurality of bins for at least one portion of the one or more pick-up orders; receiving, from one or more portable computing devices, a first electronic confirmation that the one or more portions of the one or more pick-up orders have been prepared; receiving, using the order pick-up processing server, a notification associated with the one or more pick-up orders; in response to the notification, generating, using the order pick-up processing server, one or more tasks associated with moving the one or more portions of the one or more pick-up orders prepared for pick-up before the notification from the one or more carts to a pick-up location within a pick-up facility; and receiving, from the one or more portable computing devices, a second electronic confirmation that the one or more tasks associated with moving the portions of the one or more pick-up orders have been completed, wherein the second electronic confirmation is indicative that the one or more portions of the one or more pick-up orders have been moved from the one or more carts to the pick-up location. In some embodiments, the methods further comprise preparing the one or more portions of the one or more pick-up orders using the one or more carts and moving the one or more portions of the one or more pick-up orders prepared for pick-up before the notification from the one or more carts to the pick-up location within the pick-up facility.

In some embodiments, the present disclosure provides systems that comprise: one or more portable computing devices; and one or more order pick-up processing server systems in communication with the one or more portable computing devices, the one or more order pick-up processing server systems comprising a processor and a memory device coupled to the processor, the memory device comprising instructions executable by the processor that, when executed, cause the processor to receive one or more pick-up orders; in response to the one or more pick-up orders, generate one or more tasks associated with preparing one or more portions of the one or more pick-up orders using one or more carts comprising a plurality of bins, wherein the one or more tasks comprise an assignment of at least one of the plurality of bins for at least one portion of the one or more pick-up orders; receive a first electronic confirmation from one or more portable computing devices that the one or more portions of the one or more pick-up orders have been prepared; receive a notification associated with the one or more pick-up orders; in response to the notification, generate one or more tasks associated with moving the one or more portions of the one or more pick-up orders prepared for pick-up before the notification from the one or more carts to a pick-up location within a pick-up facility; and receive a second electronic confirmation that the one or more tasks associated with moving the portions of the one or more pick-up orders have been completed, wherein the second electronic confirmation is indicative that the one or more portions of the one or more pick-up orders have been moved from the one or more carts to the pick-up location.

The features and advantages of the present disclosure will be apparent to those skilled in the art. While numerous changes may be made by those skilled in the art, such changes are within the spirit of the invention and disclosure.

### BRIEF DESCRIPTION OF THE FIGURES

Some specific example embodiments of the disclosure may be understood by referring, in part, to the following description and the accompanying figures.

FIG. 1 is a flowchart depicting a process for preparing a customer's order for pick-up by the customer according to certain embodiments of the present disclosure.

FIG. 2 is a diagram of an example pick-up facility according to certain embodiments of the present disclosure.

FIG. 3 is a diagram depicting a portion of an order fulfillment system for pick-up of items according to certain embodiments of the present disclosure.

FIG. 4 is a flowchart depicting a process for preparing a customer's order for pick-up by the customer according to certain embodiments of the present disclosure.

FIG. 5 is a flowchart depicting a process for facilitating the preparation and pick-up of items in an order using one or more carts according to certain embodiments of the present disclosure.

FIG. 6 is a flowchart depicting a process for facilitating the substitution of unavailable items according to certain embodiments of the present disclosure.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION OF EMBODIMENTS

The present disclosure generally relates to systems, computer programs, and methods for coordinating employee activities to facilitate fulfillment of orders for items and/or services sold by retailers and provided to customers for pick-up.

More particularly, the present disclosure provides systems, computer programs, and methods for generating, in response to a notification (e.g., via text message, e-mail, or other communication from a customer's portable electronic device, by checking in at a kiosk provided at the pick-up facility, and/or by checking in with personnel at the pick-up facility) associated with a previously-placed pick-up order by a customer, one or more tasks associated with moving to a pick-up location within the pick-up facility one or more portions of the order that were packaged for pick-up before the notification, and receiving electronic confirmation that the one or more tasks have been completed. The present disclosure also provides computer programs stored in a tangible medium comprising a plurality of instructions that when executed cause at least one processor to perform some or all of the methods described herein.

Among the many potential advantages to the methods and compositions of the present disclosure, only some of which are alluded to herein, the methods and systems of the present disclosure may provide a more efficient, convenient, and/or flexible means of managing pick-up of customer orders. In some embodiments, the methods and systems of the present disclosure may enable a retailer to pick, collect, or prepare items for a customer's order closer to the time at which they are actually picked up, and thus provide certain types of items to the customer in a more “fresh” state as compared to if the items were picked, collected, or prepared prior to the customer's arrival at the pick-up facility.

The retailers who may operate or use the methods and systems of the present disclosure may include any entity who sells and/or provides goods or services to customers, including but not limited to grocery retailers. The goods or items provided using the methods and systems of the present disclosure may include any suitable goods. In certain embodiments, the goods or items may comprise food or grocery items, including but not limited to pre-packaged food items, perishable food items (e.g., meat, produce, delicatessen items, bakery items, etc.), cold or refrigerated items (e.g., milk, yogurt, etc.), dry or ambient items (e.g., pasta, spices, etc.) frozen food items (e.g., ice cream, frozen foods, etc.), or bulk items (e.g., toilet paper, paper towels, packages of water bottles, etc.) and the like. These goods or items may be purchased by the retailer from another source, or may be created, packaged, or prepared (in whole or in part) by the retailer. In some embodiments, the goods or items may be “made to order” and/or customized per the customer's request and/or specifications. In certain embodiments, the goods or items may be stored and/or provided as a part of the inventory of a retail store location, either in a stockroom or in the retail space accessible to customers at the store.

In the methods and systems of the present disclosure, it is also understood that the descriptions of activities of or involving a customer (e.g., pick-up of items, arrival at a pick-up facility, triggering/sending/receiving notifications) may include those activities that may involve or be performed by a customer's agent or designee that has been tasked with picking up previously ordered items from a pick-up facility. In certain embodiments, such an agent or designee may be a representative or employee of a third-party courier, delivery, or shopping company authorized by the customer and/or retailer to pick up items ordered by the customer (either separately or through the third-party company) at the pick-up facility.

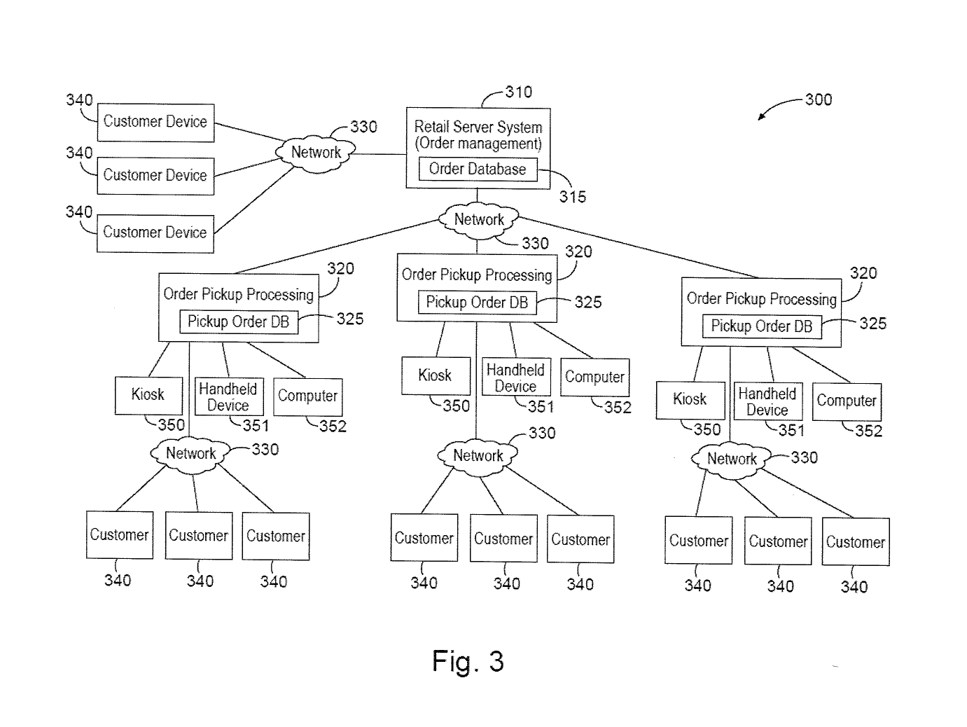

FIG. 3 illustrates an example system 300 for implementing an order fulfillment system according to certain embodiments of the present disclosure. This system involves a system configured for client-server interaction and communication, which refers to a distributed system in which a program at one site sends a request to a program at another site and waits for a response. The requesting program is called the “client,” and the program which responds to the request is called the “server.” Client-server systems may exist in the Internet (which refers to a collection of interconnected (public and/or private) networks that are linked together by a set of standard protocols (such as TCP/IP and HTTP) to form a global, distributed network), the World Wide Web, or other networks either public or private in nature. While this term may refer to what is now commonly known as the Internet, it is also intended to encompass variations which may be made in the future, including changes and additions to existing standard protocols. In the context of the Internet or the World Wide Web, the client is a “Web browser” (or simply “browser”) which runs on a computer of a user; the program which responds to browser requests by serving Web pages is commonly referred to as a “Web server.” A website or retailer server system of the present disclosure serves informational content over a network, typically using the standard protocols of the World Wide Web.

System 300 includes a retail server system 310 operated by a retailer that is connected to (e.g., through a direct communication link or a communication network) a plurality of order pick-up processing servers 320, each of which may be located at, designated for, or associated with a particular pick-up facility. In certain embodiments, one or more of order pick-up processing servers 320 may comprise virtual servers that are physically located on a single piece or group of hardware components at a single physical location (e.g., a retail store or other facility). In the embodiment shown, the retail server system 310 and each of the plurality of order pick-up processing servers 320 may be connected to and/or communicate with one or more customer devices 340 used by customers through one or more networks 330. Although FIG. 3 illustrates a particular arrangement of customer devices 340, retailer server system 310, order pick-up processing servers 320, and networks 330, this disclosure contemplates any suitable arrangement of those devices, servers, and networks. Although FIG. 3 illustrates a particular number of customer devices 340, retailer server systems 310, order pick-up processing servers 320, and networks 330, this disclosure contemplates any suitable number (e.g., one or more) of those components. As an example and not by way of limitation, system 300 instead may comprise multiple retailer server systems 310 (e.g., servers of multiple different retailers connected to common order pick-up processing servers 320 operated by a third party), or a single centralized order pick-up processing server that may process information for a plurality of different pick-up facilities. As another example and not by way of limitation, one or more retailer server systems 310 and one or more order pick-up processing servers 320 may be physically or logically co-located with each other in whole or in part. System 300 also may comprise any number of intermediate servers and/or networks between one or more of customer devices 340, retailer server systems 310, order pick-up processing servers 320, and networks 330. For example, the data provided to customer devices 340 for display to a customer and/or data provided to order pick-up processing servers 320 may be processed or passed through one or more additional servers or computer systems hosted by a third party network or server provider. Such intermediate servers and/or networks may run additional software or further process data received from customer devices 340 and/or order pick-up processing servers 320 before transmission of that data elsewhere in the system.

Server systems used in the methods and systems of the present disclosure such as retailer server system 310 and/or order pick-up processing servers 320 generally comprise at least one processor, non-transitory computer readable memory (e.g., random access memory (RAM) or read-only memory (ROM)) that may comprise executable instructions for the processor, and a communications interface configured to transmit data (e.g., pick-up time notifications and/or data relating thereto) to and receive data (e.g., customer arrival notifications and/or data relating thereto) from other computer systems or devices. The processor may comprise any microprocessor, central processing unit (“CPU”), or other computer processors known in the art, and the communications interface may comprise any type of computer interface device known or used in the art with electronics and computer systems, including but not limited to modems, Ethernet/Wi-Fi/LAN/cellular adapters, serial connections, data bus connections, and other similar types of devices. The processor may include an internal memory device and/or be configured to access a separate memory device or drive comprising executable instructions. The retailer server system also may include multiple redundant servers that operate as mirrors of each other, which may, among other purposes, increase speed of the system and/or help compensate for failures or other problems in the servers. In particular embodiments, retailer server system 310 and/or order pick-up processing servers 320 may be network-addressable computing systems that can host one or more retailer's server systems. In particular embodiments, retailer server system 310 and/or order pick-up processing servers 320 may be capable of receiving and/or generating communications in the form of email messages, text messages (e.g., SMS, MMS, or any other known format), push notifications, instant messages, voicemails, audio recordings, video recordings, or any other suitable form of electronic messages.

A retailer server system 310 may generate, store, receive, and transmit various types of data relating to online orders, including but not limited to item-related data (e.g., images, pricing, inventory availability, perishability, customization options, size/weight data, promotional information, and/or other attributes), customer-related data (e.g., names, addresses, phone numbers, e-mail addresses, communication preferences, purchase histories, payment information, etc.), store-related data (e.g., addresses, store departments, inventory, etc.) and the like. For example, as shown in FIG. 3, retailer server system 310 may include an order database 315 that stores data records for orders for items placed by a customer, for example, via an online ordering system. Those orders may be received, for instance, at the retailer server system 310 and processed into a form necessary for storage in the order database 315. This may include creating an order record in the form of a data structure that corresponds to a customer's order and includes customer-related data associated with the customer, the items within the order, and other information associated with the order, including, but not limited to, the pick-up location and pick-up date. The data structure may also be populated, for instance, with item-related data, such as a Universal Product Code (UPC), associated with the items in the order that is retrieved from other databases associated with the retailer server system 310. A retailer server system 310 may be accessed by and/or communicate with the other components of system 300, either directly or via a network or a third-party system.

The order pick-up processing servers 320 may generate, store, receive, and transmit various types of data relating to online orders (or items in such orders) to be fulfilled to the customer via a particular pick-up facility. That data may include but is not limited to item-related data (e.g., item inventory availability, perishability, customization options, size/weight data, putaway locations, and/or other attributes), customer-related data (e.g., names, addresses, phone numbers, e-mail addresses, communication preferences, purchase histories, payment information, etc.), store-related data (e.g., addresses, store departments, inventory, runner personnel information, etc.) and the like. For example, as shown in FIG. 3, order pick-up processing servers 320 may include pick-up order databases 325 that store data records or structures for orders for items to be picked up at a particular pick-up location. In certain embodiments, the pick-up order databases 325 may be populated by a certain number of order records sent by retail server system 310 or accessed from order database 315. Alternatively, pick-up orders may be transmitted from the retail server system 310 to the pick-up processing servers 320, where the servers 320 may process the order to generate and store order records in the pick-up order databases 325.

In particular embodiments, one or more customers may use one or more customer devices 340 to access, send data to, and receive data from order pick-up processing servers 320. In certain embodiments, one or more computing devices such as kiosks 350, handheld devices 351, and computer terminals 352 provided at the pick-up facility and/or operated by personnel at the pick-up facility may be connected to the order pick-up processing servers 320 to access, send data to, and receive data from order pick-up processing servers 320. In certain embodiments, the personnel-operated computing devices (e.g., a portable computing device or handheld computing device) may interact with or otherwise modify the order records in the pick-up order databases 325. The personnel-operated computing devices may further receive electronic communications from the order pick-up processing server 320. A customer device 340, kiosk 350, handheld device 351, or computer terminal 352 may access or communicate with an order pick-up processing server 320 directly, via a network (e.g., similar to network 330), or via a third-party system.

A customer device 340, kiosk 350, handheld device 351, and/or computer terminal 352 may include any suitable computing device, such as, for example, a laptop computer, a cellular phone, a smartphone, a personal digital assistant, an ultra-mobile PC, a computing tablet, a portable media player, a pocket computer, or the like. In many embodiments, the customer device 340 is a portable device such as a smart phone or tablet that a customer can easily carry when they enter the pick-up facility. In particular embodiments, the customer device 340 includes a processor, a non-transitory computer readable memory (e.g., RAM or ROM) that comprises executable instructions for the processor, and a communication interface. Kiosks 350 and/or computer terminals 352 also may comprise other forms of computing devices, including desktop computers, thin client terminals, and the like. In certain embodiments, suitable customer devices 340, kiosks 350, handheld devices 351, and/or computer terminals 352 may comprise storage, an input/output (I/O) interface, communication buses, and other components. This disclosure contemplates any suitable device having any suitable number of any suitable components in any suitable arrangement. The customer device, kiosk, handheld device, and/or computer terminal may include, incorporate, or interface with various types of input and output devices. Suitable output devices may include, but are not limited to, display monitors, audio speakers, printers, or the like. Suitable input devices may include, but are not limited to, touch screens, mouses, keyboards, microphones, motion detection systems/sensors, near-field communication devices, scanners (e.g., barcode scanners), cameras, or the like.

Networks 330 may be any suitable communications networks. As an example and not by way of limitation, one or more portions of networks 300 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 330 may include one or more networks 330.

Various types of connections may connect customer devices 340, retailer server systems 310, order pick-up processing servers 320, networks 330, kiosks 350, handheld devices 351, and/or computer terminals 352 and/or third party carrier servers to each other. This disclosure contemplates any suitable connections. In particular embodiments, one or more connections include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 301 each include an ad hoc network, an intranet, an extranet, a VPN, a LAN, a WLAN, a WAN, a WWAN, a MAN, a portion of the Internet, a portion of the PSTN, a cellular telephone network, another connection, or a combination of two or more such connections. The connections need not necessarily be the same throughout system 300. One or more first connections may differ in one or more respects from one or more second connections.

According to aspects of the present disclosure, a pick-up order from a customer may trigger a fulfillment process that controls the manner in which the pick-up order is filled and provided to the customer. The fulfillment process may be guided or otherwise controlled by one or more of the server systems 310 and 320, which may generate one or more tasks associated with the pick-up order and communicate some or all of those tasks to employees via personnel-operated computing devices, e.g., kiosks 350, handheld devices 351, and computer terminals 352. The tasks may be generated, for instance, using one or more processing algorithms implemented as software in one or more of the server systems 310 and 320, and may be represented as separate data structure or as data structures associated with a particular order. In certain embodiments, the servers 320 may generate the tasks based on an order record received from the server system 310, communicate the tasks to employees via network-connected personnel-operated computing devices, receive task completion confirmations from employees via the network-connected personnel-operated computing devices, and monitor the progress of the fulfillment process in one or more data structures, which may include the order record stored in the pick-up order databases 325 associated with the servers 320. In certain embodiments, at least some of the tasks may be triggered by customer communications received at one or more of the server systems 310 and 320.

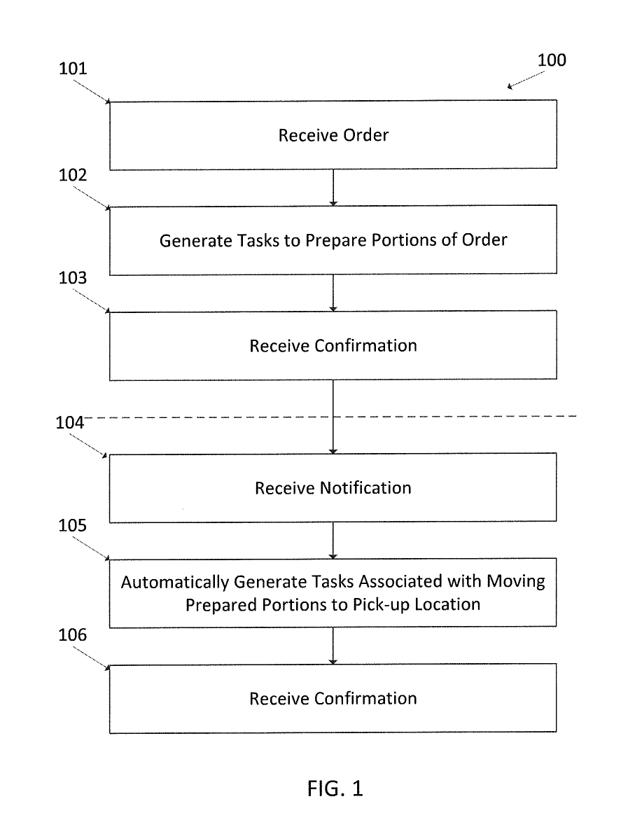

FIG. 1 is a flowchart illustrating an example fulfillment process 100 of the present disclosure that may be used to facilitate the preparation and pick-up of items in an order placed with the retailer. At step 101, the process 100 may be triggered when a pick-up order from a customer is received. The pick-up order may be placed by a customer, for instance, through an online ordering system or by phone, or during a prior visit to a retail store or other facility operated by the retailer. In certain embodiments, the particular pick-up facility where the customer will pick up their order and/or a scheduled date/time window when the order can be made available for pick-up (e.g., an earliest date/time when the order will be available) is selected and/or assigned at the time that the order was placed or at any other point in time prior to pick-up. The pick-up facility and/or the scheduled date/time for pick-up may be selected and/or assigned by the customer, the retailer, or a third party involved in the processing of the order.

In certain embodiments, the pick-up order may be received at one or more server systems associated with the order fulfillment process. This includes, for instance, the retail server system 310 and/or the order pick-up processing servers 320 described above with reference to FIG. 3. Receiving the pick-up order may include receiving a data structure associated with the pick-up order and storing the data structure within one of more databases. For instance, when a pick-up order is made through an online ordering system, the pick-up order may be packaged in a data structure that can be stored directly into an order database. Additionally, when an order is received by phone, an employee of the retailer may input the order into a system that generates or stores data within the associated data structure for the order. Alternatively, receiving the pick-up order may include processing and parsing the pick-up order to generate a data structure associated with the pick-up order that is of the form accepted by an order database.

At block 102, in the embodiment shown, one or more tasks associated with preparing one or more portions of the pick-up order may be generated automatically. The one or more tasks associated with preparing one or more portions of the pick-up order may be generated automatically, for instance, by one or more server systems associated with the fulfillment process at a set period of time before the scheduled pick-up time for the pick-up order. For instance, the one or more tasks may be generated automatically when the pick-up facility opens on the day during which the pick-up is scheduled to occur.

In certain embodiments, a portion of the pick-up order may include a subset of items within the pick-up order that share one or more common characteristics. Example characteristics include, but are not limited to, product types and product locations within the pick-up facility. Example types of products may include, but are not limited to, items in stock at the pick-up facility, items that must be shipped to the pick-up facility, and items that must be made at the pick-up location. In certain embodiments, there may be one or more subcategories based on common characteristics of products within a particular type. For instance, in the grocery retailer context, in stock items may be subdivided into frozen items and fresh produce, such that one portion of the pick-up order include in-stock frozen items and another portion of the pick-up order include in-stock produce. Generating the one or more tasks associated with preparing one or more portions of the pick-up order may include parsing or otherwise grouping at least some of the items of the pick-up order into categories based on the product characteristics. The items may be grouped or categorized, for instance, by referencing a UPC of each item with a database that identifies a product type or location associated with the item, and then grouping or associating data structures associated with like-items within the pick-up order.

In certain embodiments, the one or more tasks associated with preparing one or more portions of the pick-up order may comprise tasks associated with collecting and packaging in-stock portions of the pick-up order. For instance, one or more tasks may be generated for each in-stock portion of the order and transmitted to employees via personnel-operated computing devices, e.g., handheld devices 351.

The one or more tasks associated with preparing one or more portions of the pick-up order may further comprise tasks associated with making a product at the pick-up facility, such as a baked good, or collecting and packaging one or more items that were shipped to the stored. The employees may receive the one or more tasks and proceed to prepare the portions of the pick-up order associated with each task. The prepared portions of the pick-up order may be left, for instance, at one or more staging areas that will be discussed in detail below.

At block 103, a first electronic confirmation that the one or more portions of the pick-up order have been prepared may be received. The first electronic confirmation may comprise an electronic notification (e.g., via text message, e-mail, or other communication) from an employee transmitted through a personnel-operated computing device, e.g., handheld device 351, to one or more server systems associated with the fulfillment process 100. Once the first electronic confirmation is received, the one or more server systems may flag that the portions of the pick-up order that have been prepared and wait to proceed to the next step.

At block 104, after an unknown time-period after the portions of the pick-up order are prepared, a notification associated with the pick-up order may be received. The notification may be received, for instance, at an order pick-up processing server similar to the servers 320 described above with reference to FIG. 3. The notification may comprise a customer arrival notification identifying when the customer arrives at the pick-up facility to pick up the order. However, it will be understood by a person of ordinary skill in the art that, in certain embodiments of the present disclosure, the customer may provide a customer arrival notification at some point in time prior to their physical arrival at the pick-up facility in anticipation of that arrival. In certain embodiments, the customer may provide an arrival notification from some other location via a remote means of communication (e.g., at block 117, as described below), for example, when they are preparing to travel to the pick-up facility, while in transit to the pick-up facility, and/or from a location just outside the pick-up facility (e.g., a parking lot, drop-off location, etc.).

The customer may choose a means of notifying the order pick-up processing server of his arrival at the facility. The embodiments illustrated in FIG. 1 provides for three possible means of providing a customer arrival notification. A first means of providing notification may comprise a customer's personal device (e.g., smartphone). For instance, a customer may notify one or more servers associated with the fulfillment process, such as the order management system described with reference to FIG. 3, in the form of an email message, a text message (e.g., SMS, MMS, or any other known format), a push notification, an instant message, an audio or video recording, or any other suitable form of electronic message containing the indicated information. For instance, a customer may send an SMS text message to a phone number that is monitored by a system capable of sending data from incoming text messages to the order pick-up processing server (which may be provided to the customer in an order confirmation). The text message may include the customer's phone number (i.e., the phone number that the customer provided in placing their order), order number, or other information associated with the customer's order. The customer may enter the digits of their phone number in the SMS text message itself, or the customer's phone number may be communicated to the order pick-up processing server automatically as the number from which the message was sent.

A second means of providing notification may comprise a computing device such as a kiosk or networked computer provided at the pick-up facility. The customer may provide input on the computing device indicating their arrival, which may include the customer's phone number, order number, or other information associated with the customer's order. In certain embodiments, the computing device may be provided at a “curbside” location at the pick-up facility where customer vehicles may be parked or located, such that customer may provide their arrival notification from their vehicle and/or await delivery of the items in their order to that curbside location. The computing device sends that information to the order pick-up processing server, either via a common communication network or an electronic message generated by the computing device and sent to the order pick-up processing server as text message, e-mail message, push notification, or other type of electronic communication.

In other embodiments, the notification may comprise an automatic notification that issued a set period of time before a pre-determined pick-up time for the order, but after the one or more portions of the order have been prepared. In those embodiments, the notification may be issued or triggered by the same processing server that receives the notification, which may be the case, for instance, when one software program or subroutine tracks upcoming scheduled pick-up times, and another software program or subroutine is responsible for generating tasks associated with fulfilling the order.

Step 105 may comprise in response to the notification, automatically generating one or more tasks associated with moving to a pick-up location within the pick-up facility the one or more prepared portions of the order. The one or more tasks may be automatically generated by one or more server systems associated with the fulfillment process. As described above, the one or more portions of the order may be tracked or otherwise identified within data structures associated with the pick-up order. In certain embodiments, one task may be generated for each portion of the pick-up order, and the task may include instructions to move the associated and packaged portion of the pick-up order to a designated pick-up location within the pick-up facility.

The automatically generated tasks may be transmitted to employees via personnel-operated computing devices, e.g., handheld devices 351, similar to the manner in which the tasks to prepare the one or more portions of the order were transmitted. An employee or employees may receive the tasks via personnel-operated computing devices and proceed to move the one or more portions of the order that were packaged for pick-up to the pick-up location within the pick-up facility, as instructed by the task. Once a prepared portion of the order has been moved to the pick-up location within the pick-up facility, the employee responsible for the associated task may confirm that the task has been completed through an electronic transmission from a personnel-operated computing device to one or more servers associated with the fulfillment process 100.

At step 106, a second electronic confirmation that the one or more tasks have been completed may be received. The second electronic confirmation may comprise electronic transmissions from the employees responsible for the associated tasks, as described above. The electronic transmissions may be received at one or more servers associated with the fulfillment process. In certain embodiments, the process may further include generating an indication that an order is complete. This may include tracking confirmation with respect to each portion of the order and generating a transmission indicating order completion to an employee in charge of interacting with the customer.

In an example implementation, a customer may submit an on-line order containing a plurality of items, a phone number associated with the order, and a pick-up time and pick-up facility for the order. The pick-up order may include one or more items that may include, but are not limited to, items in stock at the pick-up facility, items that must be shipped to the pick-up facility, and items that must be made at the pick-up location. The order may be received at an order processing server, similar to the order processing server described above. Once received, the items of the pick-up order may be categorized, using their UPCs, based on their type and/or location within the pick-up facility. For instance, the items may be categorized based on whether they are in stock or must be shipped to the facility and/or, if they are in stock, their locations within the pick-up facility.

In certain embodiments, the one or more tasks associated with preparing one or more portions of the pick-up order may comprise the use of one or more carts. The carts may comprise shelves supporting a plurality of bins in which items may be placed. In some embodiments, the bins may be removable from the carts and/or movable within a cart. In certain embodiments, the bins may not be removable and may comprise a portion of the cart. In certain embodiments, the use of carts may allow preparation of more than one pick-up order at the same time. For example, in certain embodiments, two or more bins may be used to hold portions of at least two pick-up orders. Employees may use a cart to collect items for the at least two pick-up orders and store them in the plurality of bins. In some embodiments, the one or more tasks may comprise instructions to use a cart to prepare at least a portion of a plurality of pick-up orders.

In certain embodiments, the one or more carts may be mobile. For example, in certain embodiments, the one or more carts may comprise mobile means enabling the cart to be moved from one location to another. In certain embodiments, for example, the cart may comprise wheels, rollers, tracks, or similar components suitable to allow the cart to be moved. In some embodiments, the carts may be motorized, manually moveable, or both. In some embodiments, carts may be automated. In some embodiments, a cart may comprise a personnel-operated computing device, e.g., a portable computing device. The personnel-operated computing device may, for example, comprise a portion of the cart or be permanently or detachably attached to the cart.

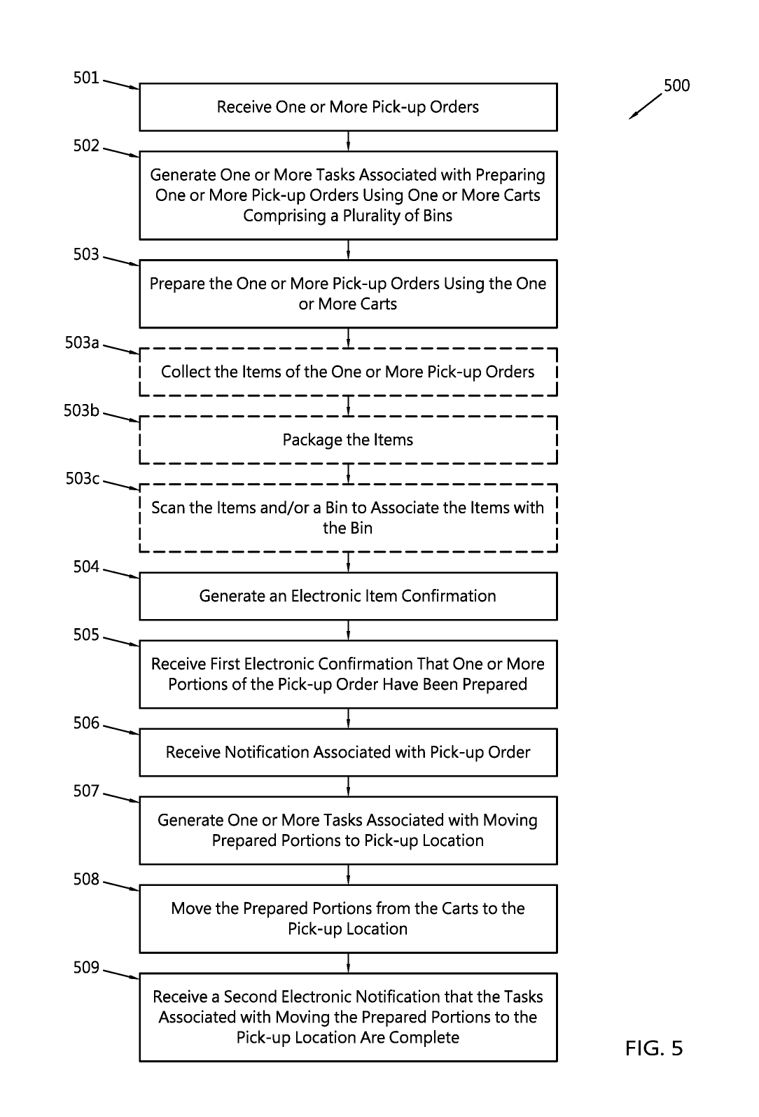

FIG. 5 is a flowchart illustrating an example fulfillment process 500 of the present disclosure that may be used to facilitate the preparation and pick-up of items in an order placed with the retailer using one or more carts. The process 500 may be triggered when a pick-up order from a customer is received 501 in a manner similar to step 101 in FIG. 1 discussed above. At block 502, in the embodiment shown, one or more tasks associated with preparing one or more portions of the pick-up order using the one or more carts may be generated. The one or more tasks associated with preparing one or more portions of the pick-up order may be generated 502, for instance, by one or more server systems associated with the fulfillment process at a set period of time before the scheduled pick-up time for the pick-up order. For instance, the one or more tasks may be generated 502 automatically when the pick-up facility opens on the day during which the pick-up is scheduled to occur. In some embodiments, the one or more tasks may comprise using one or more carts to collect at least a portion of one or more pick-up orders and place them in bins.

In some embodiments, generating one or more tasks associated with preparing one or more portions of one or more pick-up orders 502 may comprise determining how many carts are necessary to prepare the one or more pick-up orders. In certain embodiments, a plurality of tasks may be generated associated with preparing one or more portions of a plurality of pick-up orders using a single cart. In certain embodiments, a plurality of tasks may be generated associated with preparing one or more portions of a plurality of pick-up orders using one or more carts. In some embodiments, generating one or more tasks associated with preparing one or more portions of one or more pick-up orders 502 may comprise assigning the portions of the one or more pick-up orders to two or more carts. In some embodiments, a plurality of tasks may be generated associated with preparing one or more portions of a plurality of pick-up orders using a plurality of carts. In certain embodiments, a separate task may be generated for each cart that is necessary to prepare the one or more pick-up orders. In certain embodiments, a group of tasks may be generated for each cart that is necessary to prepare the one or more pick-up orders. In some embodiments, the one or more tasks may comprise an assignment of two or more portions of pick-up orders to bins in two or more carts. In some embodiments, the tasks may comprise various instructions, including, but not limited to which item goes in which bin, the sequence in which items should be collected, the order that an item is associated with, a picture of an item, a description of an item, an indication of whether an item is substitutable, notes associated with an order, a UPC number for an item, and the location of an item in the pick-up facility.

In certain embodiments, generating one or more tasks 502 may comprise determining which pick-up orders may be fulfilled using the same cart. In certain embodiments, for example, determining which pick-up orders and how many pick-up orders may be prepared using the same cart may depend, at least in part, on properties of the pick-up orders. For example, in certain embodiments, determining which pick-up orders and how many pick-up orders may be prepared using the same cart may depend, at least in part, on the dimensionality of the bins and the items in the pick-up orders, the timing of the pick-up orders, the type of items in the pick-up orders, or the location of the items in the pick-up orders in the pickup facility. In certain embodiments, generating the one or more tasks associated with preparing one or more portions of one or more pick-up orders 502 comprises determining how many bins are necessary to hold at least the portion of each pick-up order. In certain embodiments, generating one or more tasks 502 may comprise cubing out the bins in one or more carts based on the one or more pick-up orders. In some embodiments, portions of the one or more pick-up orders may be assigned to a cart based, at least in part, on the item size, item type, or location in the facility. For example, in certain embodiments, a dry portion of a pick-up order may be assigned to a first cart and a frozen portion of a pick-up order may be assigned to a second cart. In certain embodiments, dry portions of a pick-up order may be assigned a first cart, frozen portions of a pick-up order may be assigned to a second cart, cold portions of a pick-up order may be assigned to a third cart, and bulk portions of a pick-up order may be assigned to a fourth cart. In certain embodiments, generating the one or more tasks may comprise determining the optimal assignment of items in one or more pick-up orders to bins in one or more carts. Optimization may comprise optimizing for space, efficiency, preparation time, or other suitable factors. The optimal assignment of items, for example, may comprise an assignment of items to bins that results in the least amount of bins used per pick-up order or the least amount of bins used per portion of pick-up order.

In some embodiments, one or more tasks related to the same cart may be assembled into a task group. In certain embodiments, a task group may be assigned to the same one or more employees. In certain embodiments, tasks in a task group may be arranged in an order for the one or more employees to complete. In some embodiments, the tasks in a task group may be ordered in the group based, at least in part, on the location of the items in a facility. In some embodiments, the tasks in a task group may be ordered in the group based, at least in part, on an optimal path for the items to be collected. In certain embodiments, the tasks in a task group may be ordered in the group based, at least in part, on the acceptable length of time that each item may be on the cart. For example, in some embodiments, a task for collecting ice cream may be at the end of the task group.

In some embodiments, step 503 comprises preparing the one or more pick-up orders using the one or more carts. In some embodiments, preparing the one or more pick-up orders comprises collecting the items 503a and packaging the items 503b by bagging them as they are added to the cart. In some embodiments, carts may comprise an apparatus for packaging the items. For example, in certain embodiments, a cart may comprise a bag holder (e.g., a typical plastic bag frame or stand used to bag groceries during check out) to facilitate packaging the items. In some embodiments, the one or more tasks may comprise scanning the items and/or the bins to associate the items with the bins in which they are placed 503c. In some embodiments, in response to scanning an item to associate it with a bin, one or more electronic item confirmations may be generated 504. In certain embodiments, the electronic item confirmations may be generated 504 by a portable computing device and received by an order pick-up processing server. In some embodiments, the electronic item confirmation may comprise information regarding the bin and cart to which the item was added.

The cart bins may be used to keep items for one or more pick-up orders separate. In some embodiments, at least one of the bins is assigned to at least a portion of a particular pick-up order. For example, in certain embodiments, one or more bins may be assigned to hold certain items of a pick-up order. In certain embodiments, more than one bin may be needed to fit the items for at least a portion of the pick-up order. The number of bins in a cart assigned to the pick-up order may be determined based, at least in part, on item-related data (e.g., perishability, customization options, size/weight data, putaway locations, and/or other attributes). In some embodiments, the number of items in a bin is determined based, at least in part, on the bin size and item-related data. In some embodiments, the bins assigned to the at least a portion of the pick-up order may be determined based, at least in part, on the weight of the items in the portion of the pick-up order. For example, in certain embodiments, heavier items may be preferentially assigned to lower bins on a cart.

In certain embodiments, bins may be identified by a number, a letter, or other suitable identifier. In some embodiments, carts may be identified by the type of item it is used to collect (e.g., dry, cold, refrigerated, bulk, frozen) and a number, letter, or other suitable identifier. In some embodiments, carts may comprise a bar code, matrix code, radio-frequency identifier (RFID) tag, or other means by which the identity of the cart may be scanned. In some embodiments, bins may comprise a bar code, matrix code, radio-frequency identifier (RFID) tag, or other means by which the identity of the bin may be scanned.

In some embodiments, carts may be available in different configurations. In certain embodiments, the cart may comprise different sized bins for receiving larger quantities of items and/or for receiving physically larger items. For example, in certain embodiments, cart configurations may vary in the number of bins, sizes of bins, number of shelves, height between shelves, shelf depth, maximum recommended load capacity, and other characteristics. In some embodiments, a cart may comprise bins of the same size. Certain configurations of carts may be preferable for certain applications, pick-up orders, or combinations of pick-up orders. For example, a large, heavy-duty cart may be desired for collecting large items or a large number of items, and carts with a variety of different heights, widths, or depths may be better suited to picking particular items or to entering aisles on which items are located. In some embodiments, a cart may comprise twelve bins. In certain embodiments, different carts may be designed to be suitable for a particular type of items. For example, a cart may be suitable for frozen items, refrigerated items, bulk items, dry items, or ambient items. In certain embodiments, for example in the case of a pick-up order comprising frozen, refrigerated, bulk, and dry items, four different configurations of carts may be used. In certain embodiments, cart configuration may be dynamic and an employee may be able to change or reconfigure a cart. In certain embodiments, generating one or more tasks associated with preparing one or more portions of pick-up orders may comprise determining what configuration of carts are necessary to prepare the one or more pick-up orders. In certain embodiments, the one or more tasks may comprise instructions on what type of cart or cart configuration is to be used to prepare the one or more pick-up orders. In certain embodiments, the one or more tasks may comprise instructions to reconfigure one or more carts.

In certain embodiments, once the portions of the one or more pick-up orders are prepared, the cart may be left, for example, at one or more staging areas. In some embodiments, the cart may be scanned when it is left at a staging area to associate the cart with the staging area. In certain embodiments, the cart may be scanned to associate the cart with a particular location within the staging area. In some embodiments, a first electronic notification may be automatically generated and sent to the order pick-up processing server upon the cart being scanned to associate it with a staging area. In some embodiments, some or all of the items may be offloaded from a cart into a staging area. For example, in certain embodiments, items may be offloaded from a cart into a refrigerated or frozen staging area.

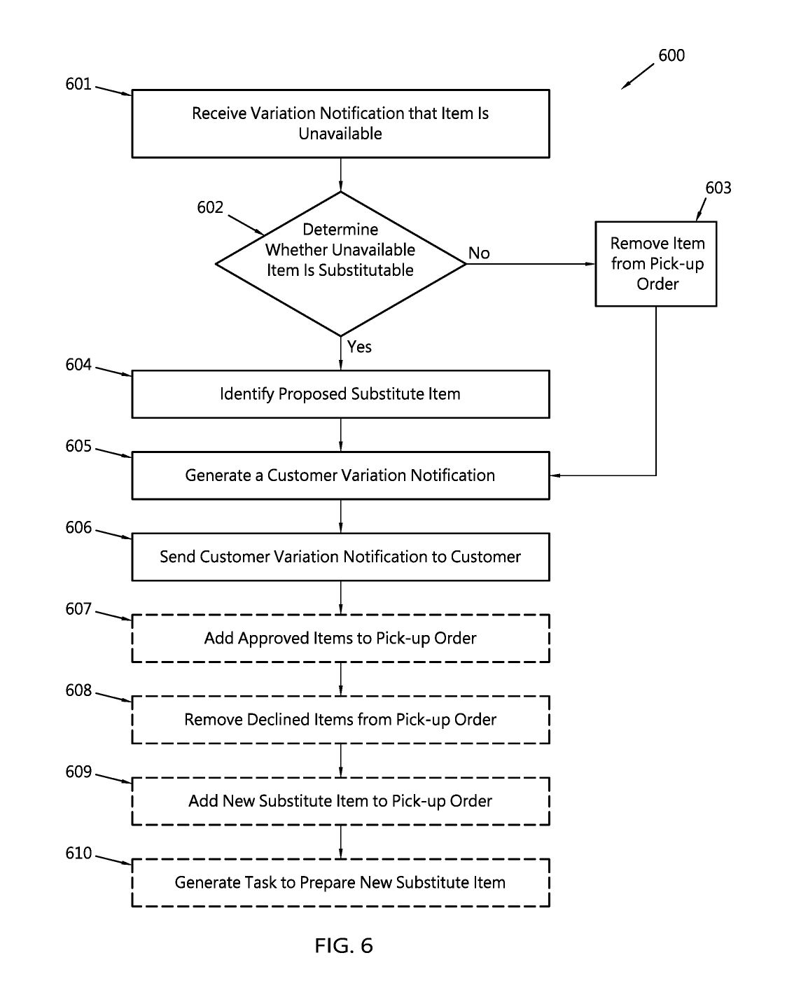

In some embodiments, a variation may occur during the preparing the one or more pick-up orders using the one or more carts 503 where an employee is unable to collect an item. For example, in certain embodiments, an item may be out of stock. FIG. 6 is a flowchart illustrating an example process 600 of the present disclosure that may be used to facilitate the substitution of unavailable items. At block 601, a variation notification may be received that at least a portion of a pick-up order is unavailable. In some embodiments, the variation notification may be generated by a personnel-operated computing device. At block 602, in response to the variation notification, an order pick-up processing server may determine whether the item is substitutable. In certain embodiments, determining whether an item is substitutable may comprise comparing the item UPC with a list of substitutable items or looking up a database with information on whether that item is substitutable. If the item is not substitutable (e.g., it is a unique item with no close analog), it may be removed from the pick-up order 603 so that the customer is not charged for the item. If the item is substitutable, a proposed substitute item may be identified 604. Blocks 601-604 may be repeated for additional unavailable items in the pick-up order. At block 605, a variation customer notification may be generated using the order pick-up processing server. In certain embodiments, the variation customer notification may comprise a list of the unavailable items and any proposed substitute items. For example, in certain embodiments, the variation customer notification may be a text message and may comprise a link to the list of unavailable items. In some embodiments, the variation customer notification may provide an option for the customer to respond to the proposed substitute items. For example, in certain embodiments, the variation customer notification may allow the customer to accept, decline, or search for a new substitute item in response to a proposed substitute item. At block 606, the variation customer notification is sent to a customer. The variation customer notification and/or the customer's response may be sent via text message, e-mail, mobile application, or other communication.

In some embodiments, if the customer approves the item, it is added to the pick-up order 607. In certain embodiments, if the customer declines the item, it is removed from the pick-up order 608. In some embodiments, the variation customer notification may allow the customer to select and/or search for a different substitute item. If the customer selects a different or new substitute item, it may be added to the pick-up order 609. In some embodiments, a task may be generated to prepare the new substitute item for pick-up 610.

Returning to FIG. 5, at block 505 a first electronic confirmation that the one or more portions of the pick-up order have been prepared may be received. The first electronic confirmation may be generated and received in the same manner as the confirmation in step 103 of FIG. 1, discussed above. Once the first electronic confirmation is received, the one or more server systems may flag that the portions of the pick-up order that have been prepared and wait to proceed to the next step. In some embodiments, the confirmation that the one or more portions of the pick-up order have been prepared may comprise a notification that a cart comprising one or more portions of the pick-up order has been left in a staging area. In some embodiments, the confirmation may further comprise a particular location within the staging area where the cart is located.

At block 506, after an unknown time-period after the portions of the pick-up order are prepared, a notification associated with the pick-up order may be received. The notification may be received in the same manner as described above with respect to block 104 in FIG. 1.

At block 507, in response to the notification, one or more tasks may be generated associated with moving to a pick-up location within a pick-up facility from the one or more carts the one or more portions of the one or more pick-up orders prepared for pick-up before the notification. The one or more tasks may be generated 507 by one or more server systems associated with the fulfillment process. As described above, the one or more portions of the order may be tracked or otherwise identified within data structures associated with the pick-up order. In certain embodiments, one task may be generated for each portion of the pick-up order, and the tasks may include instructions to move the associated and packaged portion of the pick-up order to a designated pick-up location from the one or more carts within the pick-up facility. In certain embodiments, the tasks may include instructions to move the associated and packaged portion of the pick-up order from one or more bins of one or more carts to a designated pick-up location within the pick-up facility.

The generated tasks may be transmitted to employees via personnel-operated computing devices, e.g., handheld devices 351, similar to the manner in which the tasks to prepare the one or more portions of the order were transmitted. An employee or employees may receive the tasks via personnel-operated computing devices and proceed to move the one or more portions of the order that were packaged for pick-up to the pick-up location within the pick-up facility, as instructed by the task. Once a prepared portion of the order has been moved to the pick-up location within the pick-up facility, the employee responsible for the associated task may confirm that the task has been completed through an electronic transmission from a personnel-operated computing device to one or more servers associated with the fulfillment process 500.

A block 508, the portions of the one or more pick-up orders prepared for pick-up before the notification may be moved to a pick-up location within a pick-up facility. At block 509, a second electronic confirmation that the one or more tasks associated with moving the prepared portions to the pick-up location have been completed may be received. The second electronic confirmation may comprise electronic transmissions from the employees responsible for the associated tasks, as described above. The electronic transmissions may be received at one or more servers associated with the fulfillment process. In certain embodiments, the process may further include generating an indication that an order is complete. This may include tracking confirmation with respect to each portion of the order and generating a transmission indicating order completion to an employee in charge of interacting with the customer.

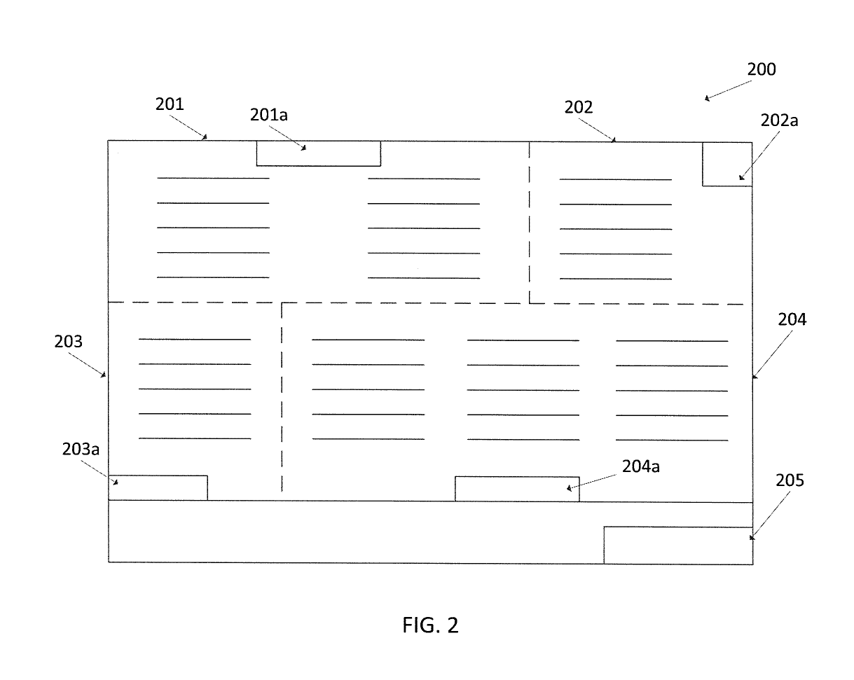

FIG. 2 illustrates an example pick-up facility 200 that has been divided into a plurality of sectors 201-204, each illustrated with shelves or other display features. The sectors 201-204 may comprise different types of products. For instance, in a grocery retailer context, sectors 201 and 204 may comprise boxed items, sector 202 may comprise frozen items, and sector 203 may comprise fresh produce. Items that are in stock may be categorized based on the sector in which they are located within the store. The items within the same sector may be grouped together and form one portion of the order. Items that must be made at the pick-up facility may comprise one or more other portions of the order. Items that must be shipped to the store may comprise still one or more other portions of the order.

When the pick-up facility 200 opens on the day during which the pick-up is to occur, tasks associated with preparing one or more portions of the pick-up order may be generated automatically. For instance, if the order included three frozen items and four items of fresh produce, two tasks for the pick-up order may be generated, one to collect and package the frozen items, and one to collect and package the produce. In certain embodiments, some or all of the sectors 201-204 may have designated staging areas 201a-204a in which the prepared and packaged portions of the order may be left after they are prepared and packaged. For instance, the staging area 202a for sector 202, which contains the frozen items, may comprise a freezer dedicated to holding packaged portions of pick-up orders. Similarly, the staging area 203a for sector 203, which contains produce, may comprise a refrigerator dedicated to holding packaged portions of pick-up orders. Other staging areas may include shelves or other segregated areas where packaged portions of pick-up orders may be left.

The tasks for preparing and packaging the portions of the order may be received by one or more employees on handheld electronic devices. In certain embodiments a task for a particular portion of the order may comprise a list of items included in that portion of the order that must be collected and packaged. In some embodiments, each task is associated with an individual item, and a group of tasks is assigned to an employee handling a single cart. In certain embodiments, the employee in charge of performing that task may then collect the listed items, package them together, leave the packaged portion of the order at a designated staging area, and generate a transmission indicating that the task is completed. In certain embodiments, one or more of the employees may be dedicated to a particular sector 201-204 of the store, and all tasks associated with preparing and packaging portions of the order associated with that sector may be sent to the corresponding employee or employees.

In certain embodiments, one or more tasks for preparing and packaging portions of one or more pick-up orders may be received by one or more employees on handheld electronic devices. The one or more tasks may comprise a list of items included in those portions of the one or more orders that must be collected and packaged using a cart. In certain embodiments, the one or more tasks may also comprise information about cart configuration and bin assignment for each item in the portions of the pick-up orders. In some embodiments, the one or more employees in charge of performing the tasks may then use the cart to collect the listed items, package them, place them in the assigned bins in the cart, leave the cart at a designated staging area, and generate a transmission indicating that the task is completed.

Once confirmation that the portions of the order have been prepared is received, the process may stop until a customer notification is received. The notification may comprise a text message from the customer indicating that they are ready to pick-up the order. At that time, tasks associated with moving the prepared portions of the order from their staging area to a particular pick-up location in the store may be automatically generated and transmitted to employees. One pick-up location 205 is indicated in FIG. 2 but it should be appreciated that more than one pick-up location within the pick-up facility 200 is possible.

One or more employees may receive the tasks through their electronic device, identify the correct prepared portion of the order from its associated staging area, and move the prepared portion of the order to the pick-up location 205. In certain embodiments, the tasks may comprise moving the prepared portions of a pick-up order from one or more bins on one or more carts to the pick-up location 205. In addition, tasks associated with moving other portions of the order, such as items shipped to the pick-up location or items made at the pick-up location, may be generated. One or more employees may receive those tasks, retrieve the shipped or made items, and take those items to the pick-up location. When each item or packaged portion of the order is delivered to the pick-up location 205, an electronic confirmation may be generated from the employee's electronic device and received at one or more server systems associated with the fulfillment process.

In addition to many advantages that would be appreciated by a person of ordinary skill in the art in view of this disclosure, the above described process may help facilitate on-time delivery of pick-up orders. Specifically, because portions of the order may be prepared and packaged before the pick-up time, the time to deliver the pick-up order to the customer once the customer arrives is reduced. Moreover, the use of designated staging areas allows for items to be packaged and tracked ahead of time, and provides for the use of specific equipment, including freezers and refrigerators, to maintain the freshness of pre-packaged products.

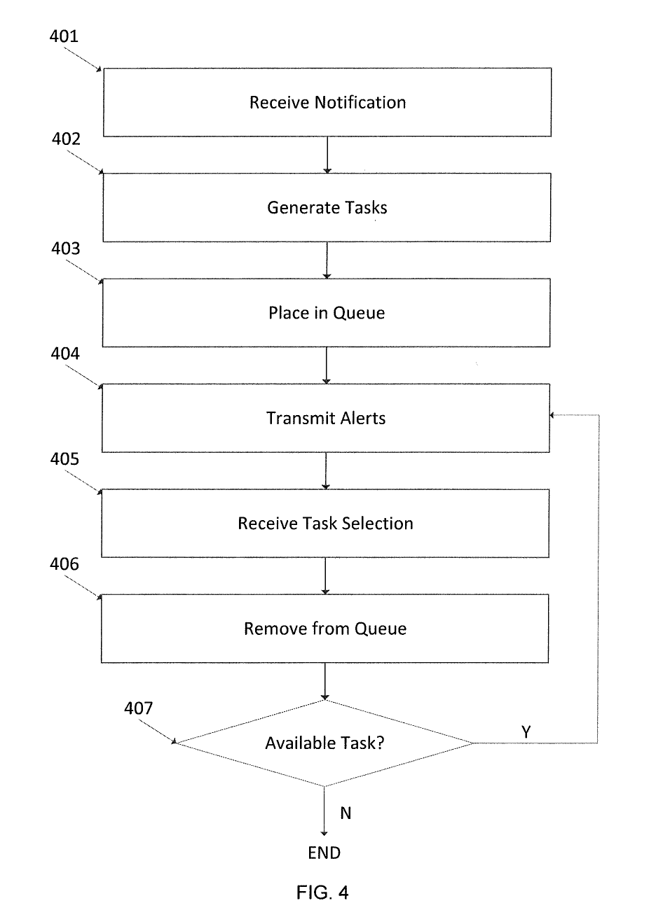

FIG. 4 illustrates an example process 400 for generating tasks associated with the fulfillment process described in FIG. 1. For instance, the process 400 may be incorporated at step 105 above and implemented by one or more servers associated with the fulfillment process 100. Step 401 of the process 400, includes receiving a notification associated with a pick-up order, which may comprise, for instance, the customer arrival notification discussed above with reference to FIG. 1. At step 402, one or more tasks associated with a pick-up order may be generated, including, but not limited to, one or more tasks associated with moving to a pick-up location within a pick-up facility one or more portions of a pick-up order that were packaged for pick-up before the notification.

At step 403, the process may include placing the generated tasks in one or more queues of tasks. For instance, each of the tasks associated with a particular order may be placed in a queue. Alternatively, one or more queues may be dedicated to sectors of a pick-up facility, such that tasks associated with items or packaged pick-up orders within a given sector may be placed within a single queue. This may be useful, for instance, where notifications associated with multiple pick-up orders have been received, and there may be packaged portions of different orders that must be moved from the staging area of a given sector to the pick-up location. In some embodiments, the generated tasks may be grouped into a group of tasks in the queue (e.g., if the tasks involve the use of a single cart).

At step 404, alerts may be transmitted to electronic devices of one or more employees indicating that there are tasks within one or more queue. For instance, where one employee is responsible for a particular sector, that employee may be notified when there are queued tasks corresponding to that sector awaiting performance. Where there are not dedicated employees, one or more designated employee runners may be notified when there are queued tasks awaiting performance.

At step 405, a task selection from one or more employees may be received. The task selection may comprise an automatic transmission from an employee's electronic device indicating that the employee has selected a task (or group of tasks) from the queue. The task selection may be transmitted to and received by one or more server system associated with the fulfillment process.

At step 406, in response to receiving the task or task group selection, the selected task or task group may be removed from the queue. This step may be performed automatically, for instance, by a server system that receives the selection and is responsible for generating and tracking the performance of tasks within the fulfillment process.

At step 407, it may be determined whether unselected tasks or task groups remain within the queue or queues. If so, the process may return to step 404, and an alert may be transmitted to an employee or employee at the pick-up facility that there are un-selected tasks. This process may continue until all of the tasks have been selected and removed from the queue.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method, comprising:
receiving, using an order pick-up processing server, one or more pick-up orders;
in response to the one or more pick-up orders, generating, using the order pick-up processing server, one or more tasks associated with preparing one or more portions of the one or more pick-up orders using one or more carts comprising a plurality of bins, wherein the one or more tasks comprise an assignment of at least one of the plurality of bins for at least one portion of the one or more pick-up orders;
receiving, from one or more portable computing devices, a first electronic confirmation that the one or more portions of the one or more pick-up orders have been prepared;
receiving, using the order pick-up processing server, a notification associated with the one or more pick-up orders;
in response to the notification, generating, using the order pick-up processing server, one or more tasks associated with moving the one or more portions of the one or more pick-up orders prepared for pick-up before the notification from the one or more carts to a pick-up location within a pick-up facility; and
receiving, from the one or more portable computing devices, a second electronic confirmation that the one or more tasks associated with moving the portions of the one or more pick-up orders have been completed, wherein the second electronic confirmation is indicative that the one or more portions of the one or more pick-up orders have been moved from the one or more carts to the pick-up location.

2. The method of claim 1, wherein the one or more tasks associated with preparing the one or more pick-up orders further comprise leaving the one or more carts at one or more staging areas within the pick-up facility.

3. The method of claim 1, wherein the one or more tasks comprise packaging items of the one or more portions of the one or more pick-up orders and placing them in at least one of the plurality of bins.

4. The method of claim 1, wherein a plurality of tasks are generated associated with preparing one or more portions of a plurality of pick-up orders using one of the one or more carts.

5. The method of claim 1, wherein generating the one or more tasks associated with preparing the one or more portions of the one or more pick-up orders comprises determining how many bins are necessary to hold the one or more portions of each pick-up order.

6. The method of claim 1, wherein generating the one or more tasks associated with preparing the one or more portions of the one or more pick-up orders comprises determining how many carts are necessary to prepare the one or more pick-up orders.

7. The method of claim 1, wherein the notification comprises a customer arrival notification indicating that the customer has arrived at the pick-up facility.

8. The method of claim 1, further comprising receiving, from one or more portable computing devices, an electronic item confirmation that an item has been placed in at least one of the plurality of bins.

9. The method of claim 1, further comprising:
receiving, from one or more portable computing devices, a variation notification that an item of the one or more pick-up orders is unavailable;
in response to the variation notification, generating, using the order pick-up processing server, a variation customer notification; and
sending the variation customer notification to a customer.

10. The method of claim 1, wherein generating, using the order pick-up processing server, one or more tasks associated with moving to the pick-up location within the pick-up facility from the one or more carts the one or more portions of the order prepared for pick-up before the notification comprises:
placing the one or more tasks within a queue of tasks for personnel on duty at the pick-up facility; and
transmitting an electronic alert associated with the one or more tasks to the one or more portable computing devices associated with the personnel on duty at the pick-up facility.

11. The method of claim 10, wherein receiving the second electronic confirmation that the one or more tasks have been completed comprises:
receiving notification from the one or more portable computing devices that the personnel has selected a task from the queue of tasks;
removing the selected task from the queue; and
receiving notification from the one or more portable computing devices that the one or more portions of the pick-up order associated with the selected task have been moved to the pick-up location.

12. A system, comprising:
one or more portable computing devices; and
one or more order pick-up processing server systems in communication with the one or more portable computing devices, the one or more order pick-up processing server systems comprising a processor and a memory device coupled to the processor, the memory device comprising instructions executable by the processor that, when executed, cause the processor to
receive one or more pick-up orders;
in response to the one or more pick-up orders, generate one or more tasks associated with preparing one or more portions of the one or more pick-up orders using one or more carts comprising a plurality of bins, wherein the one or more tasks comprise an assignment of at least one of the plurality of bins for at least one portion of the one or more pick-up orders;
receive a first electronic confirmation from one or more portable computing devices that the one or more portions of the one or more pick-up orders have been prepared;
receive a notification associated with the one or more pick-up orders;
in response to the notification, generate one or more tasks associated with moving the one or more portions of the one or more pick-up orders prepared for pick-up before the notification from the one or more carts to a pick-up location within a pick-up facility; and
receive a second electronic confirmation that the one or more tasks associated with moving the portions of the one or more pick-up orders have been completed, wherein the second electronic confirmation is indicative that the one or more portions of the one or more pick-up orders have been moved from the one or more carts to the pick-up location.

13. The system of claim 12, wherein the notification comprises a customer arrival notification indicating that the customer has arrived at the pick-up facility.

14. The system of claim 12, wherein the one or more tasks associated with preparing the one or more pick-up orders further comprise leaving the one or more carts at one or more staging areas within the pick-up facility.

15. The system of claim 12, wherein the one or more tasks comprise packaging items of the one or more portions of the one or more pick-up orders and placing them in at least one of the plurality of bins.

16. The system of claim 12, wherein a plurality of tasks are generated associated with preparing one or more portions of a plurality of pick-up orders using one of the one or more carts.

17. The system of claim 12, wherein the executable instructions that, when executed, cause the processor to generate one or more tasks associated with moving to the pick-up location within the pick-up facility from the one or more carts one or more portions of the pick-up order prepared for pick-up before the notification further cause the processor to
place the one or more tasks within a queue of tasks for personnel on duty at the pick-up facility; and
transmit an electronic alert associated with the one or more tasks to the one or more portable computing devices associated with the personnel on duty at the pick-up facility.

18. The system of claim 17, wherein the executable instructions that, when executed, cause the processor to receive the second electronic confirmation that the one or more tasks have been completed further cause the processor to:
receive notification from the one or more portable computing devices that the personnel has selected a task from the queue of tasks;
remove the selected task from the queue; and
receive notification from the one or more portable computing devices that the one or more portions of the order associated with the selected task have been moved to the pick-up location.

19. The system of claim 12, wherein the one or more portable computing devices are handheld devices.

20. A method, comprising:
receiving, using an order pick-up processing server, one or more pick-up orders;
in response to the one or more pick-up orders, generating, using the order pick-up processing server, one or more tasks associated with preparing one or more portions of the one or more pick-up orders using one or more carts comprising a plurality of bins, wherein the one or more tasks comprise an assignment of at least one of the plurality of bins for at least a portion of the one or more pick-up orders;
preparing the one or more portions of the one or more pick-up orders using the one or more carts;
receiving, from one or more portable computing devices, a first electronic confirmation that the one or more portions of the one or more pick-up orders have been prepared;
receiving, using the order pick-up processing server, a notification associated with the one or more pick-up orders;
in response to the notification, generating, using the order pick-up processing server, one or more tasks associated with moving the one or more portions of the one or more pick-up orders prepared for pick-up before the notification from the one or more carts to a pick-up location within a pick-up facility;
moving the one or more portions of the one or more pick-up orders prepared for pick-up before the notification from the one or more carts to the pick-up location within the pick-up facility; and
receiving, from the one or more portable computing devices, a second electronic confirmation that the one or more tasks associated with moving the portions of the one or more pick-up orders have been completed, wherein the second electronic confirmation is indicative that the one or more portions of the one or more pick-up orders have been moved from the one or more carts to the pick-up location.
